(19) United States
(12) Patent Application Publication
(10) Pub. No.: US 2008/0123362 A1
(43) Pub. Date: May 29, 2008

(54) ILLUMINATED POLE

(76) Inventors: Greg THORNEYCROFT, Newport (AU); Grant WHITE, Gladstone Park (AU)

Correspondence Address: RICHARD M. GOLDBERG, 25 EAST SALEM STREET, SUITE 419, HACKENSACK, NJ, 07601, US

(21) Appl. No.: 11/560,933

(22) Filed: Nov. 17, 2006

(30) Foreign Application Priority Data
Nov. 3, 2006 (AU) 2006100940

(51) Int. Cl. F21V 7/04; F21S 4/00

(52) U.S. Cl. 362/558; 362/223

(57) ABSTRACT

An illuminatable dance pole includes a longitudinal internal structural (3) member running the substantial length of the pole, an optical diffusion sleeve (2) of generally cylindrical cross-section encasing the structural member along all or part of the length thereof, and an external optically transparent sleeve (1) such that the external sleeve, the diffusion sleeve and the structural member are fitted for coaxial and contiguous engagement in at least three positions on the circumference of each respective member or sleeve so as to provide a visually transparent and structurally supported dance pole.

### INTRODUCTION TO THE INVENTION

This invention relates to the entertainment and leisure industry and in particular to a particular type of dancing, utilising a vertically positioned cylindrical pole as a basis and focus upon which a particular style of dancing is executed.

Such dance poles traditionally comprise of a sturdy vertical pole rigidly anchored and of sufficient rigidity and structural strength to withstand the forces imposed by the acrobatic and gymnastic exertions typified by the style of dancing. Dance poles must provide sufficient structural strength to hold a dancer but also provide a sufficiently safe and hygienic surface to support the dancer who relies to a large part, on the pole for support and leverage. To date, such dance poles are constructed of rigid materials, primarily of steel, aluminium or other substantial materials.

In order to enhance the attraction of such a dancing style, it will be desirable to augment dance poles with illuminated lighting and effects. However, the available poles to date, rely on their structural strength in the use of metal componentry which does not lend itself to the inclusion of visual and illuminated display.

It will be desirable to provide a dance pole capable of including visual and optical display and one object of the invention is to provide an improved dance pole.

### STATEMENT OF THE INVENTION

In a first aspect the invention provides an illuminatable pole comprising a longitudinal internal structure member, running the substantial length of said pole and an external optically transparent sleeve wherein said structural member and said external sleeve are fitted for coaxial and contiguous engagement in at least three positions on the internal circumference of said external sleeve so as to provide a visually transparent and structurally supported pole.

In another aspect the invention provides an illuminatable dance pole comprising a longitudinal internal structural member running the substantial length of said pole, an optical diffusion sleeve of generally cylindrical cross section encasing said structural member along all or part of the length thereof and an external optically transparent sleeve wherein said external sleeve, said diffusion sleeve and said structural member are fitted for co-axial and contiguous engagement at at least three positions on the circumference of each perspective member or sleeve so as to provide a visually transparent and structurally supported dance pole.

The pole may include an illuminating means positioned between said structural member and said diffusion sleeve.

The illuminating means may include fibre optical cable or any other means of generating light between said structural member and said diffusion sleeve along part or all the longitudinal length of said pole.

The fibre optical cable may be fitted as a bundle substantially occupying the cavity between said structural member and said diffusion sleeve.

The structural member may be either solid or hollow form in a variety of cross-sections including square tubing, triangular tubing, round tubing with at least three longitudinal ribs, square bar, triangular bar, round bar with at least three longitudinal ribs, solid shapes including cruciform, star and triangulated.

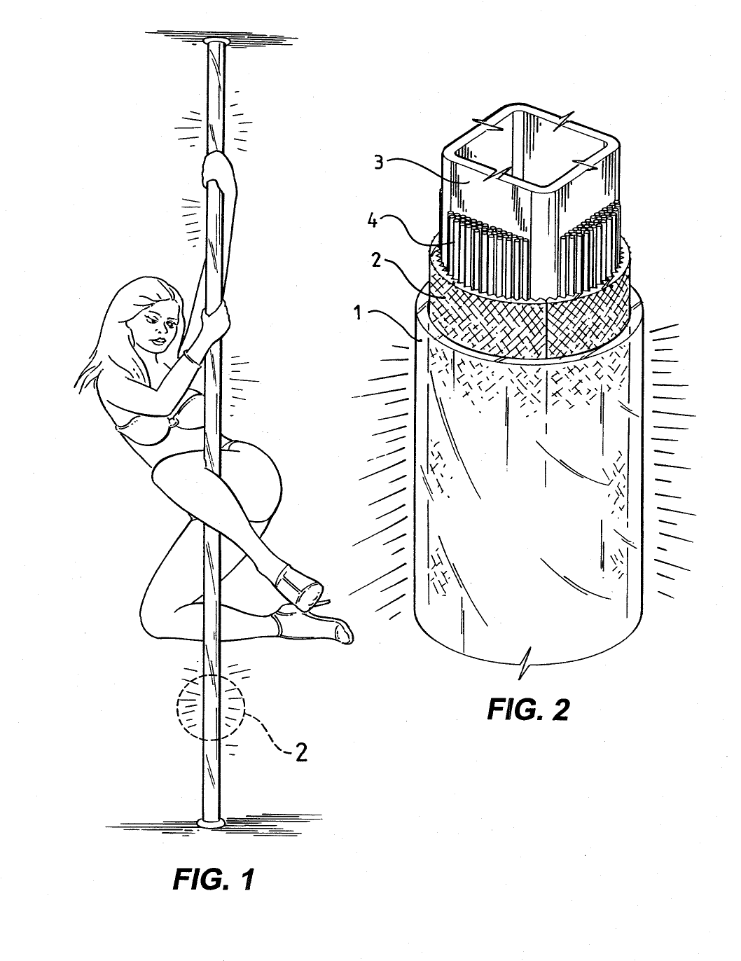

FIG. 1 shows a perspective view of the pole in use.

FIG. 2 shows a sectional view of the pole.

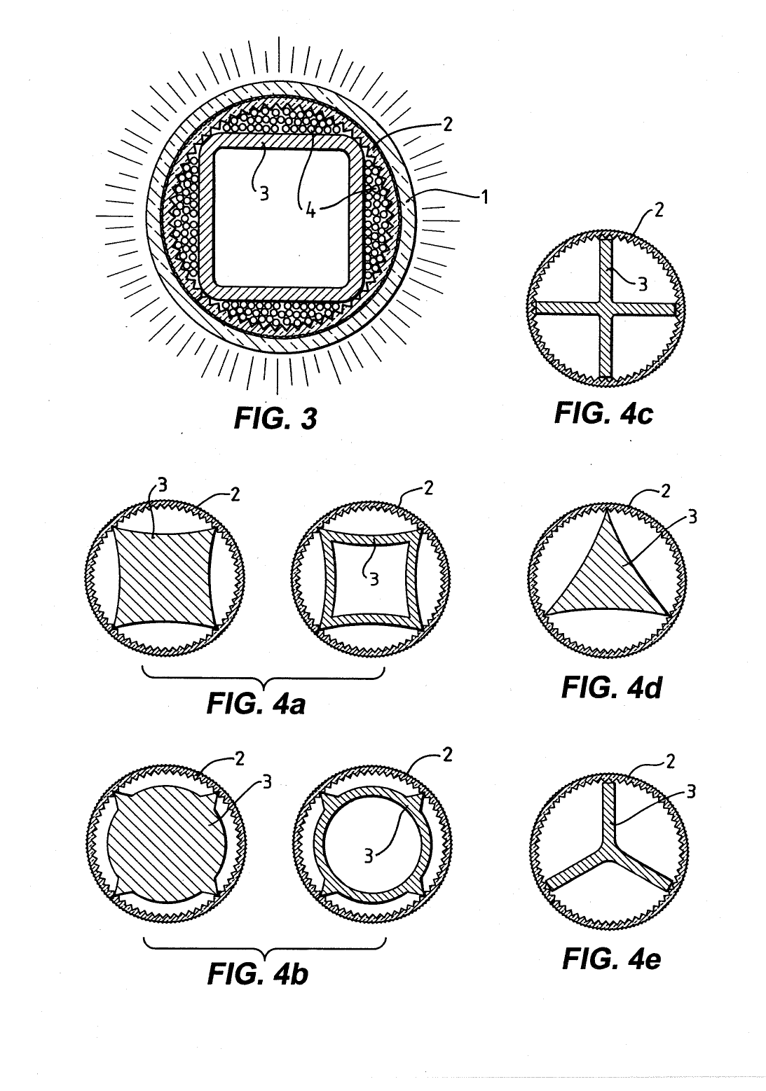

FIG. 3 shows a cross-section of the pole.

FIGS. 4a-4e show a cross-section view of alternative options for the structural member of the pole.

| Legend | |
|---|---|
| 1. | External sleeve |
| 2. | Optical diffusion sleeve |
| 3. | Structural member |
| 4. | Illuminating means |

### DETAILED DESCRIPTION OF THE INVENTION

The invention will now be described with particular reference to FIGS. 1 to 4 which detail one particularly preferred embodiment of the invention.

Referring now to the Figures, the invention provides an illuminatable dance pole comprising a longitudinal internally positioned structural member 3, taking the form as shown in FIGS. 2 and 3 of a square section steel pipe or tube. The strength and workability of the steel tube provides the integral structural strength and composition of the dance pole and runs the substantial length of the pole which as shown in FIG. 1, is firmly fitted to the ground and the ceiling so as to provide adequate support for a dancer. The longitudinal internal structural member is then encased or surrounded by a generally cylindrical shaped or configured sleeve having generally optically transparent and diffusion characteristics which can be provided by an array of internal score lines fitted on the internal side of the sleeve or alternatively can be provided by an opaque composition of the sleeve. The optical diffusion sleeve 2 is formed preferably as a complete cylinder encasing the longitudinal internal structural member so as to form a generally cylindrical configuration along the whole length of the internal structural member. The dance pole then comprises an external optically transparent sleeve 1 adapted for snug engagement to the diffusion sleeve such that the external optically transparent sleeve forms the interface for the dancer or user of the pole and faithfully reflects the physical characteristics including size, resilience and strength required by the user and reflects the type of characteristics generally experienced by users with conventional dance poles.

The illuminating means for the dance pole can be provided by one or more bundles of optical fibres 4 which are adapted for positioning most preferably between the structural member 3 and the optical diffusion sleeve 2. The optical fibre bundles provide the means of generating light within the structure of the dance pole and the optical qualities of the diffusion sleeve and external sleeve provides for the transmission of light from the pole through the diffusion and external sleeves.

The strength and structural integrity of the pole are ensured where the internal structural member is configured for coaxial engagement with the external transparent sleeve and/or the intermediate optical diffusion sleeve in such a manner as to provide contiguous engagement at at least three positions communicating directly with the internal circumference of the external sleeve. The contiguous engagement and communication between the external sleeve and the internal structural member including the diffusion sleeve ensures that the structural rigidity and strength of the internal structural member are faithfully communicated and transmitted to the external sleeve thereby faithfully transmitting the rigidity and structural strength of the internal structural member to the dancer or user of the pole via the external sleeve.

The structural member in addition to the particularly preferred embodiment shown in FIGS. 2 and 3 can adopt a range of alternative embodiments shown in FIGS. 4a through to 4e. These embodiments include both solid and hollow configurations with 4a showing a solid structural member having four contiguous contact points and a hollow version thereof also maintaining four contiguous contact points. FIG. 4b shows an alternative version of the structural member comprising a solid round section and a hollow tube version thereof with both these versions including four contact contiguous points taking the form of longitudinal ribs running down the length of the tubing. FIG. 4d shows a triangulated version of the structural member with FIG. 4e showing another alternative in the form of a star and FIG. 4c showing the cruciform version. In all versions of the structural member at least three contiguous points of contact are maintained along the whole length of the pole so as to ensure faithful maintenance of the structural strength and rigidity of the pole along the whole length and exterior surface of the transparent sleeve.

In an alternative embodiment the optical diffusion sleeve may be eliminated with the external sleeve incorporating optical diffusion features in addition to the optical transparency.

The illuminating means preferably comprises a number of optical fibre bundles which can occur as a cable, braid or gel-free form. The external sleeve preferably comprises a polycarbonate or acrylic plastic material but can comprise any equally suitable visually transparent materials.

Whilst the invention is particularly concerned with the provision of a dance pole, various applications and modifications of the invention could see the pole of the invention configured as a handrail adapted for use on stairways or other environments, particularly in environments of low light levels, where illumination of the handrail could be provided at a low level whilst ensuring the physical strength and reliability of the handrail as required for safety and health purposes.

It will be appreciated by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive.

What is claimed is:

1. An illuminatable pole comprising:
a longitudinal internal structural member running a substantial length of said pole, and
an external optically transparent sleeve, said structural member and said external sleeve being fitted for coaxial and contiguous engagement in at least three positions on the an internal circumference of said external sleeve, so as to provide a visually transparent and substantially supported pole.

2. An illuminatable dance pole comprising:
a longitudinal internal structural member running a substantial length of said pole,
an optical diffusion sleeve of generally cylindrical cross-section encasing said structural member along all or part of the length thereof, and
an external optically transparent sleeve, said external sleeve, said diffusion sleeve and said structural member being fitted for coaxial and contiguous engagement in at least three positions on the a circumference of each respective member or sleeve so as to provide a visually transparent and structurally supported dance pole.

3. A pole according to claim 1, further including an illuminating arrangement positioned between said structural member and said external sleeve.

4. A pole according to claim 3, wherein said structural is a square section metal tube.

5. A pole according to claim 4, wherein said illuminating arrangement includes at least one fiber optic cable.

6. A dance pole according to claim 2, further including an illuminating arrangement positioned between said structural member and said external sleeve.

7. A dance pole according to claim 6, wherein said structural member is a square section metal tube.

8. A dance pole according to claim 7, wherein said illuminating arrangement includes at least one fiber optic cable.
